(19) United States
(12) Patent Application Publication
(10) Pub. No.: US 2014/0174251 A1
(43) Pub. Date: Jun. 26, 2014

(54) TUBULAR MECHANICAL CONNECTING ROD

(71) Applicant: AIRCELLE, Gonfreville L'Orcher (FR)

(72) Inventor: Nicolas DEZEUSTRE, Le Havre (FR)

(73) Assignee: AIRCELLE, Gonfreville L'Orcher (FR)

(21) Appl. No.: 14/171,024

(22) Filed: Feb. 3, 2014

Related U.S. Application Data
(63) Continuation of application No. PCT/FR2012/051670, filed on Jul. 13, 2012.

(30) Foreign Application Priority Data
Aug. 1, 2011 (FR) 11/57035

(51) Int. Cl. F16C 7/02

(52) U.S. Cl. CPC F16C 7/02
USPC 74/579 R

(57) ABSTRACT

A tubular connecting rod includes a hollow body including at least one end provided with an opening and a connecting rod head arranged to be fitted through the opening. The connecting rod head includes at least one shoulder arranged to position the connecting rod head relative to the opening of the hollow body in a predetermined locked position. In particular, the end of the hollow body is provided with at least one slot.

### CROSS-REFERENCE TO RELATED APPLICATIONS

This application is a continuation of International Application No. PCT/FR2012/051670, filed on Jul. 13, 2012, which claims the benefit of FR 11/57035, filed on Aug. 1, 2011. The disclosures of the above applications are incorporated herein by reference.

### FIELD

The present disclosure relates to a tubular mechanical connecting rod.

### BACKGROUND

The statements in this section merely provide background information related to the present disclosure and may not constitute prior art.

Tubular mechanical connecting rods, i.e., with hollow bodies, are used in particular in fields where there is a constant concern for increasing mass.

These fields in particular the aeronautics field: tubular mechanical connecting rods are for example used in landing gear (brake bars), systems for keeping the maintenance cowls in the open position (engine cowl, etc.), engine suspension systems (interface transmitting thrust between the engine and the mast of the wing), etc.

A tubular mechanical connecting rod is traditionally made up of a hollow body, including a connecting rod head at each of its ends.

Each connecting rod head is typically configured in the form of a male or female yoke, so as to allow the connecting rod to be fastened by pins or any other means to the members with which it must cooperate.

In the prior art, and in particular in EP 1,870,196, a method is known for manufacturing a tubular connecting rod, in which the hollow body of the connecting rod on the one hand, and the two connecting rod heads on the other hand, are manufactured separately, then said connecting rod heads are attached at each of the ends of the hollow body, by welding.

The drawback of this method lies in the fact that it is necessary to perform welding operations at two separate locations of the connecting rod. However, the welding operations are very delicate and require extremely rigorous checks.

Furthermore, with this earlier design, it is not possible to inspect or machine the parts of the weld beads that emerge inside the hollow body of the connecting rod, due to the fact that they are enclosed inside the volume defined by said hollow body.

The geometric accident resulting from the lower part of the toe of the welding bead additionally causes a local strain concentration that requires making the area to be welded locally thicker. Consequently, it is necessary to provide a local overthickness (at the assembly zones) of the metal alloy (typically with a base of nickel, titanium or aluminum) forming the connecting rod. The excess mass related thereto is therefore doubled in the presence of two welds.

To resolve the latter drawback, it has been considered to use a single weld of two connecting rod halves each incorporating their respective heads, each half being formed in a single piece. This solution, described in the EP 0,839,593, effectively allows a reduction in the overall mass of the connecting rod relative to a connecting rod with two welds, but does not resolve the problem of inspecting and machining the inner part of the welding bead.

Thus, the manufacture of tubular mechanical connecting rods using welding operations is delicate and generally, due to the drawbacks inherent to the welding outlined above, requires additional machining steps to obtain a connecting rod with a geometry and mass that are compliant with the specifications in force in the aeronautic field.

In fact, in that field, a connecting rod must be able to react the considerable thrust forces created by the turbojet engine, while preserving as small a mass as possible. That is why it is important on the one hand for the metal alloy forming the connecting rod to be as suitable as possible for the operating conditions, so as to have the most interesting possible specific properties (mechanical properties divided by the density), and on the other hand for the connecting rod to be tubular.

### SUMMARY

The present disclosure provides a tubular connecting rod comprising:

a hollow body including at least one end provided with an opening,
a connecting rod head arranged to be fitted through the opening,
said connecting rod head including at least one locking means arranged to position the connecting rod head relative to the opening of the hollow body in a predetermined locked position, said tubular connecting rod being characterized in that the end of the hollow body is provided with at least one slot.

In the context of the present disclosure, the term “fitted” means that the connecting rod head is secured to the end of the hollow body by locked adjustment. The locked adjustment is obtained due to the shape matching of the connecting rod head and the end of the hollow body and which allows the connecting rod head to be snapped in the end of the hollow body in a predetermined locking position.

In one form, the end of the hollow body is provided with multiple uniformly distributed slots that emerge on the opening of the hollow body. This imparts an elasticity to the hollow body and thereby facilitates the reaction of the dimensional allowances between the first part or the second part of the connecting rod head and the hollow body.

Advantageously, the end of the slot on the non-through side is provided with a spoke to limit the stream concentrations, that spoke even being able to be larger than the half-width of the slot.

According to another form of the present disclosure, the connecting rod head is a single piece.

In still another form, the connecting rod head is formed by:

a first part that includes at least one first locking means arranged to position said first part relative to the opening of the hollow body in a first predetermined locking position, and
a second part that includes at least one second locking means arranged to position said second part relative to the hollow body in a second predetermined locking position.

In this form, the first part and the second part of the connecting rod head may have been obtained by cutting out a whole connecting rod head.

If the connecting rod head is formed by two separate parts as described above, it has the advantage of not being faced with strict dimensional allowance requirements that must be respected when an essentially cylindrical part is fitted in a hollow cylinder.

According to the present disclosure, the first part and the second part of the connecting rod head can be inserted in the hollow body and pressed against the hollow body, even with the extreme dimensional allowances of the hollow body and the head of the connecting rod, said two-part connecting rod head allowing play between those two parts.

If the connecting rod head is a single piece, the compensation of the dimensional allowances is done with the slots of the hollow body.

The alloys used to form the tubular connecting rod according to the present disclosure are typically alloys with a base of nickel, iron, titanium or aluminum.

In one form of the present disclosure, the locking means is a shoulder.

Advantageously, the end of the hollow body comprises at least one first fastening means designed to fasten the end of the hollow body on the connecting rod head. This first fastening means may be an orifice for inserting a fastening screw. Advantageously, this first fastening means may comprise a counterbore or a port. This imparts a good force distribution on the fastening screw head.

In one form of the present disclosure, the connecting rod head comprises at least one second fastening means designed to cooperate with the first fastening means so as to fasten the end of the hollow body on the connecting rod head. Advantageously, the second fastening means is a bore.

In another from, the hollow body has an excess thickness at its end. This imparts the advantage of ensuring better burring resistance of the hollow body. To produce this excess thickness, the hollow body is advantageously made by flow turning. Flow turning consists of deforming the preform on a mandrel by forming using one or more wheels. This makes it possible to obtain the desired thickness variations of the hollow body of the tubular connecting rod simply, quickly and without removing material.

In one form of the present disclosure, the tubular connecting rod comprises:

a hollow body including two ends each provided with an opening,
two connecting rod heads arranged to be fitted through each of the openings,
said two connecting rod heads including at least one locking means arranged to position the connecting rod head in a predetermined locked position relative to the opening of the hollow body.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 shows a perspective view of a support structure for a turbojet engine on an aircraft mass incorporating two tubular connecting rods according to the present disclosure;

FIG. 2 is a perspective view of part of one of the two tubular connecting rods shown in FIG. 1;

FIG. 3 is a front view of part of one of the two tubular connecting rods shown in FIG. 1; and

FIG. 4 is a cross-sectional view along plane IV of FIG. 2 of the tubular connecting rod part of FIG. 2.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

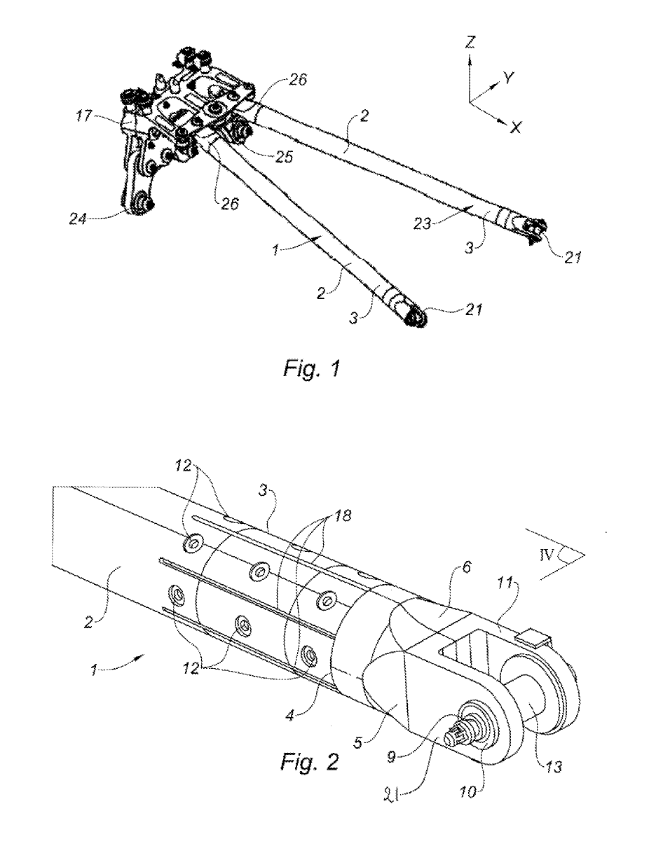

In FIG. 1, reference X, Y, Z respectively designates the axial, transverse and vertical directions of a turbojet engine (not shown) designed to cooperate with the suspension device shown in that figure.

The suspension device shown in FIG. 1 includes two tubular connecting rods 1, 23, whereof the first ends 3 each include a female yoke designed to cooperate with a front part of the turbojet engine, and whereof the second ends 26 each include a male yoke (not shown in FIG. 1) that cooperates with a suspension beam 17. The suspension beam 17 is designed to cooperate with a suspension mast of the turbojet engine (not shown), and with the shroud of the intermediate casing, by means of suitable connecting rods 24, 25.

As shown in FIG. 4, the shoulder 19 constitutes a first locking means for the first part 5 of the connecting rod head 21 relative to the opening 4 of the hollow body 2. The shoulder 20 constitutes a second locking means for the second part 6 of the connecting rod head 21 relative to the opening 4 of the hollow body 2.

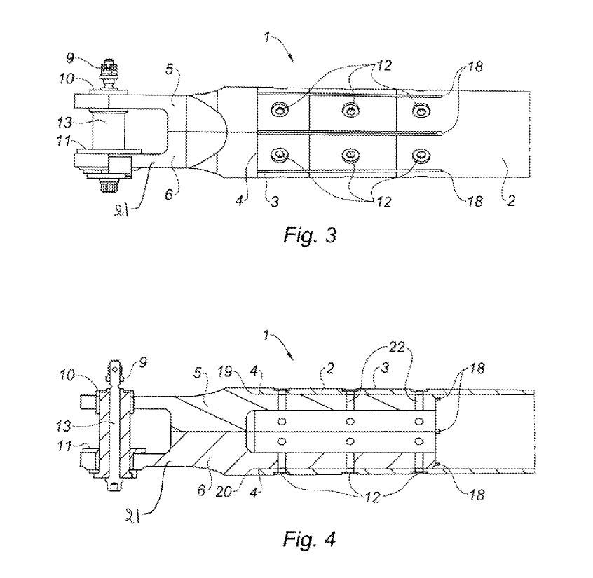

On the tubular connecting rod part 1 shown in FIGS. 2 to 4, the end 3 is provided with multiple counterbores 12 in which fastening screws (not shown) can be inserted. Additionally, as shown in FIG. 4, the first part 5 and the second part 6 of the connecting rod head 21 are provided with multiple bores 22 positioned such that when said first and second parts 5, 6 are positioned in their first predetermined locking position and a second predetermined locking position, respectively, the bores 22 are in the extension of the counterbores 12 and fastening screws will be able to be inserted.

Advantageously, the piercings of the hollow body 2 and the first 5 and/or second 6 parts of the head of the connecting rod 21 will be able to be done in a single operation, once the first parts 5 and/or second parts 6 of the connecting rod head 21 are positioned relative to the hollow body 2.

The end 3 of the hollow body 2 is provided with multiple slots 18 that emerge on the opening 4, which give it a certain elasticity and thereby facilitate the fitting of the connecting rod head 21 in the hollow body 2.

Additionally, as shown in FIGS. 2 to 4, the connecting rod head 21 comprises an axle 13, a nut 9, and rings 10 and 11. This connecting rod head 21 may also include a ball joint (not shown).

1. A tubular connecting rod comprising:
a hollow body including at least one end provided with an opening; and
a connecting rod head arranged to be fitted through the opening, said connecting rod head including at least one locking means arranged to position the connecting rod head relative to the opening of the hollow body in a predetermined locked position,
wherein the end of the hollow body is provided with at least one slot.

2. The tubular connecting rod according to claim 1, wherein the at least one locking means is a shoulder.

3. The tubular connecting rod according to claim 1, wherein the end of the hollow body comprises at least one first fastening means to fasten the end of the hollow body on the connecting rod head.

4. The tubular connecting rod according to claim 3, wherein the at least one first fastening means is an orifice for the insertion of a fastening screw.

5. The tubular connecting rod according to claim 4, wherein the at least one first fastening means is a counterbore or a port.

6. The tubular connecting rod according to claim 3, wherein the connecting rod head comprises at least one second fastening means cooperating with the at least one first fastening means so as to fasten the end of the hollow body on the connecting rod head.

7. The tubular connecting rod according to claim 6, wherein the at least one second fastening means is a bore.

8. The tubular connecting rod according to claim 1, wherein the hollow body has an overthickness at its end.

9. The tubular connecting rod according claim 1, wherein the connecting rod head is a single piece.

10. The tubular connecting rod according to claim 1, wherein the connecting rod head is formed by:
a first part that includes at least one first locking means arranged to position said first part relative to the opening of the hollow body in a first predetermined locking position; and
a second part that includes at least one second locking means arranged to position said second part relative to the hollow body in a second predetermined locking position.

11. The tubular connecting rod according to claim 10, wherein the first part and the second part of the connecting rod head have been obtained by cutting out a whole connecting rod head.

12. The tubular connecting rod according to claim 1, wherein said tubular connecting rod comprises:
a hollow body including two ends each provided with an opening; and
two connecting rod heads arranged to be fitted through each of the openings, said two connecting rod heads including at least one locking means arranged to position the connecting rod head in a predetermined locked position relative to the opening of the hollow body.
